(19) United States
(12) Patent Application Publication
(10) Pub. No.: US 2013/0021231 A1
(43) Pub. Date: Jan. 24, 2013

(54) LIQUID CRYSTAL DISPLAY DEVICE

(71) Applicants: Yuki Kawashima, Osaka-shi (JP); Keisuke Yoshida, Osaka-shi (JP); Yohsuke Fujikawa, Osaka-shi (JP); Yasutoshi Tasaka, Osaka-shi (JP); Yoshimizu Moriya, Osaka-shi (JP)

(72) Inventors: Yuki Kawashima, Osaka-shi (JP); Keisuke Yoshida, Osaka-shi (JP); Yohsuke Fujikawa, Osaka-shi (JP); Yasutoshi Tasaka, Osaka-shi (JP); Yoshimizu Moriya, Osaka-shi (JP)

(21) Appl. No.: 13/638,083

(22) PCT Filed: Mar. 11, 2011
(86) PCT No.: PCT/JP2011/055827

§ 371 Date: Sep. 28, 2012

(30) Foreign Application Priority Data
Apr. 2, 2010 (JP) 2010-086444

(51) Int. Cl. G09G 3/36

(52) U.S. Cl. 345/98

(57) ABSTRACT

In a liquid crystal display device (20), a liquid crystal panel (14) is divided into a display region (15a) including a plurality of pixels (10a) and a display region (15b) including a plurality of pixels (10b). A memory circuit (1) is provided to each pixel (10a) included in the display region (15a). The memory circuit (1) is capable of storing a data signal supplied from a signal line (3). As such, writing the data signal, which has been stored in the memory circuit (1), into a pixel electrode (2) allows an image to be displayed in accordance with the data signal. That is, in the display region (15a), it is possible to display an image without supplying image data from the outside via a scanning line (4) and the signal line (3). This allows a reduction in electric power consumption.

### TECHNICAL FIELD

The present invention relates to a liquid crystal display device including a switching element for each pixel.

### BACKGROUND ART

In recent years, research and development of display devices has been actively conducted, and a thin flat panel display (FPD) has come into wide use in place of a display device employing a cathode-ray tube, which was conventionally the mainstream. Examples of a display element used in the FPD include a liquid crystal, a light-emitting diode (LED), an organic electroluminescent (EL), or the like. Among many display mediums, a liquid crystal display device (LCD) employing a liquid crystal has been particularly actively researched and developed.

Conventionally, the mainstream of liquid crystal display devices has been a transmissive liquid crystal display device in which a backlight provided on a rear surface of a display panel is turned on so as to display an image in a transmissive manner. However, since the backlight of the transmissive liquid crystal display device needs to be always in an on-state, the transmissive liquid crystal display device has a large electric power consumption. To address this problem, there has been developed a reflective liquid crystal display device which uses, as a light source, light from outside which is reflected by means of (i) a reflecting plate provided inside the reflective liquid crystal display device or (ii) a reflecting electrode, provided as a pixel electrode, which reflects incident light from outside. The reflective liquid crystal display device needs no backlight since incident light from outside is reflected inside the reflective liquid crystal display device so as to be utilized as a display light source. This makes it possible to reduce electric power consumption of the liquid crystal display device. Further, the reflective liquid crystal display device can be made thinner and lighter than the transmissive liquid crystal display device. This allows the reflective liquid crystal display device to be suitably applied to a mobile device.

However, since the reflective liquid crystal display device as described above has no backlight, an image displayed by the reflective liquid crystal display is hardly visible in a case where there is little light around the reflective liquid crystal display. That is, the reflective liquid crystal display device is given limitations in terms of an environment in which the reflective liquid crystal display device is used. To address this problem, there has been disclosed a transflective liquid crystal display device which has both the characteristics of the reflective liquid crystal display device and the characteristics of the transmissive liquid crystal display device.

In the transflective liquid crystal display device, light from outside enters the transflective liquid crystal display device downward, and light from a backlight enters the transflective liquid crystal display device upward. The light from outside is reflected from an electrode, and the light from the backlight passes through an electrode. The transflective liquid crystal display device thus includes a plurality of pixels each having (i) a part constituted by an electrode which transmits light from the backlight and (ii) a part constituted by an electrode which reflects light from the outside. As such, the transflective liquid crystal display device makes it possible to display an image in accordance with a transmissive mode and an image in accordance with a reflective mode at the same time, by means of light transmitted from the backlight and light reflected after having entered the transflective liquid crystal display device from outside. The transflective liquid crystal display device can be thus used (i) as a reflective liquid crystal display device by turning off the backlight in a case where there is much light around the transflective liquid crystal display device and (ii) as a transmissive liquid crystal display device by turning on the backlight in a case where there is little light around the transflective liquid crystal display device. Accordingly, the configuration can reduce time during which the backlight is in an on-state. This allows electric power consumption to be reduced as much as possible.

Liquid crystal display devices are widely used in electronic devices such as a television receiver, a personal computer, a mobile phone, and a digital camera. For mobile devices such as a mobile phone and a digital camera, a liquid crystal display having lower electric power consumption is required. In terms of low electric power consumption, reduction in electric power consumption of a display panel is an important issue. As such, in recent years, techniques for further reducing electric consumption of a liquid crystal display device has been developed.

For example, Patent Literature 1 discloses a liquid crystal display device having two display regions. Details of the liquid crystal display device are illustrated in FIG. 9. FIG. 9 is a plan view schematically illustrating a liquid crystal display device 30 disclosed in Patent Literature 1. Specifically, as illustrated in FIG. 9, the liquid crystal display device 30 has two display regions: a reflective region 25a in which an image is displayed by a light reflective method and a reflective and transmissive region 25b in which an image is displayed by a combination of the light reflective method and a light transmissive method. A pixel electrode in the reflective region 25a is obtained by patterning a conductive light-reflecting film into a predetermined shape, and a pixel electrode in the reflective and transmissive region 25b is obtained by forming one or more openings in a conductive light-reflecting film and patterning the conductive light-reflecting film into a predetermined shape. A backlight is provided at a position corresponding to the reflective and transmissive region 25b.

According to the configuration, light from the backlight is utilized only in the reflective and transmissive region 25b. This allows a reduction in electric power consumption of the backlight. In addition, the backlight can be provided at a position where the reflective and transmissive region 25b is irradiated with light. This allows the liquid crystal display device 30 to be light in weight as compared with a case in which a backlight is provided so as to irradiate an entire surface of a display region.

### CITATION LIST

### Patent Literature

Patent Literature 1

Japanese Patent Application Publication, Tokukai, No. 2002-303863 A (Publication Date: Oct. 18, 2012)

### SUMMARY OF INVENTION

### Technical Problem

Although the technique disclosed in Patent Literature 1 described above reduces electric power consumption as compared with a transmissive liquid crystal display device, the reduction is not necessarily achieved to a large enough extent.

Since mobile devices such as a mobile phone and a digital camera are rapidly spreading, there is an increased demand for a mobile device having low electric power consumption. As such, in the future, there will be an even greater demand for a liquid crystal display device having low electric power consumption. As is clear from the technique disclosed in Patent Literature 1, merely improving a configuration of a display panel cannot achieve enough reduction in electric power consumption.

The present invention is accomplished in view of the problem. An object of the present invention is to provide a liquid crystal display device that enables a further reduction in electric power consumption.

### Solution to Problem

In order to attain the object, a liquid crystal display device in accordance with the present invention is a liquid crystal display device including a display screen which includes: a plurality of scanning lines; a plurality of signal lines which intersect with the plurality of scanning lines; and a plurality of pixels provided separately for respective intersections of the plurality of scanning lines and the plurality of signal lines, each of the plurality of pixels including a pixel electrode, a counter electrode facing the pixel electrode, and a liquid crystal layer provided between the pixel electrode and the counter electrode, the display screen being divided into (i) a first display region which includes a plurality of first pixels as the plurality of pixels and (ii) a second display region which includes a plurality of second pixels as the plurality of pixels, the plurality of second pixels being different from the plurality of first pixels, each of the plurality of first pixels including a memory circuit for storing a data signal supplied from a corresponding one of the plurality of signal lines.

According to the configuration, the liquid crystal display device in accordance with the present invention includes the first display region constituted by the plurality of first pixels and the second display region constituted by the plurality of second pixels. The memory circuit is provided corresponding to each of the plurality of first pixels constituting the first display region. The memory circuit is a circuit which can store the data signal supplied from the corresponding one of the plurality of signal lines. Supplying a voltage to the pixel electrode in accordance with the data signal stored in the memory circuit and writing the voltage into a liquid crystal capacitor in accordance with a potential difference between the voltage applied to the pixel electrode and a voltage of the counter electrode allows image to be displayed in accordance with the data signal. That is, it is possible to display image without supplying image data from the outside via a scanning line or a signal line. Accordingly, in a case of displaying the same image data in the first display region, it is possible to display image without continuing to supply image data from the outside. This makes it possible to supply image data to the pixel electrode without driving the scanning line and the signal line. Accordingly, the image can be displayed with low electric power consumption.

Additional objects, feature, and strengths of the present invention will be made clear by the description below. Further, the advantages of the present invention will be evident from the following explanation in reference to the drawings.

### Advantageous Effects of Invention

In the present invention, image data (data signal) stored in a memory circuit is written into a pixel electrode, so that an image can be displayed without supplying image data from the outside via a scanning line and a signal line. That is, in a case of displaying the same image data in the first display region, it is possible to display image without continuing to supply image data from the outside. This enables image data to be supplied to the pixel electrode without driving the scanning line and the signal line. Accordingly, the image can be displayed with low electric power consumption.

### BRIEF DESCRIPTION OF DRAWINGS

FIG. 1 is an equivalent circuit diagram illustrating an entire electric configuration of a liquid crystal display device in accordance with an embodiment of the present invention.

FIG. 2 is a plan view schematically illustrating an entire configuration of a liquid crystal display device in accordance with an embodiment of the present invention.

FIG. 3 is an enlarged schematic view illustrating a pixel in accordance with an embodiment of the present invention.

FIG. 4 is a view illustrating an example of arrangement of display regions in accordance with an embodiment of the present invention.

(a) of FIG. 5 is an enlarged schematic view illustrating a pixel in accordance with an embodiment of the present invention corresponding to a case in which a transmissive method is employed. (b) of FIG. 5 is an enlarged schematic view illustrating a pixel in accordance with an embodiment of the present invention corresponding to a case in which a transflective method is employed.

FIG. 6 is an equivalent circuit diagram illustrating an entire electric configuration of a liquid crystal display device in accordance with an embodiment of the present invention.

FIG. 7 is an equivalent circuit diagram illustrating an entire electric configuration of a liquid crystal display device in accordance with an embodiment of the present invention.

FIG. 8 is an equivalent circuit diagram illustrating an entire electric configuration of a liquid crystal display device in accordance with an embodiment of the present invention.

FIG. 9 is a plan view schematically illustrating an entire configuration of a conventional liquid crystal display device.

### DESCRIPTION OF EMBODIMENTS

(Outline of Liquid Crystal Display Device 20)

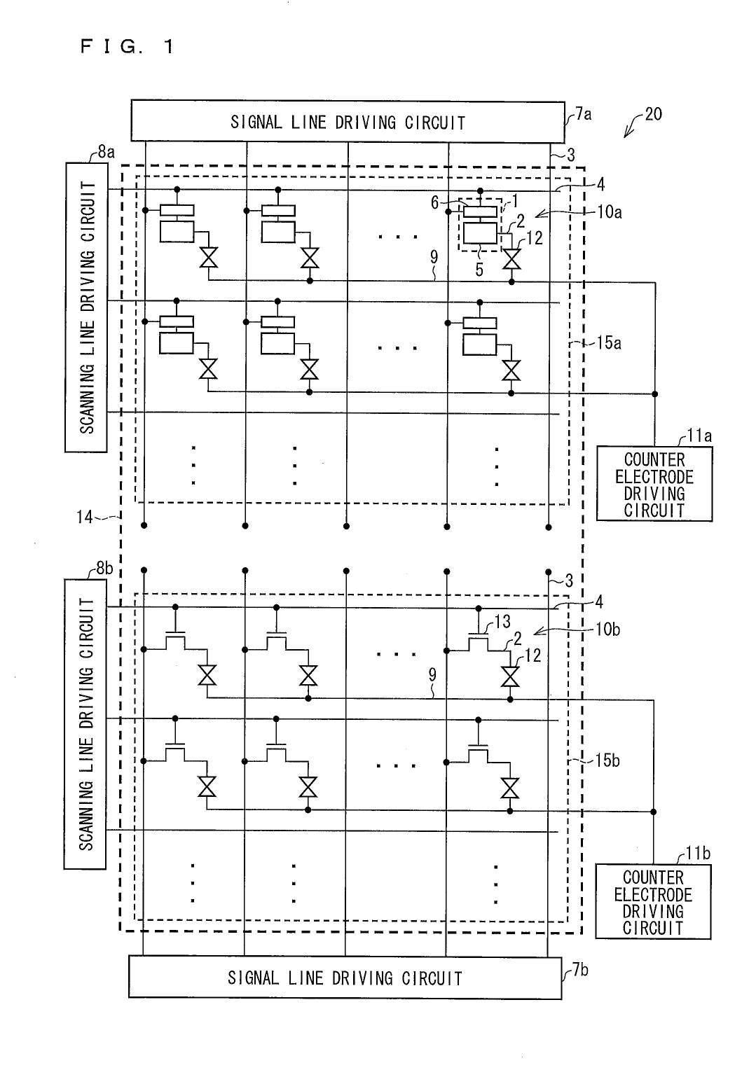

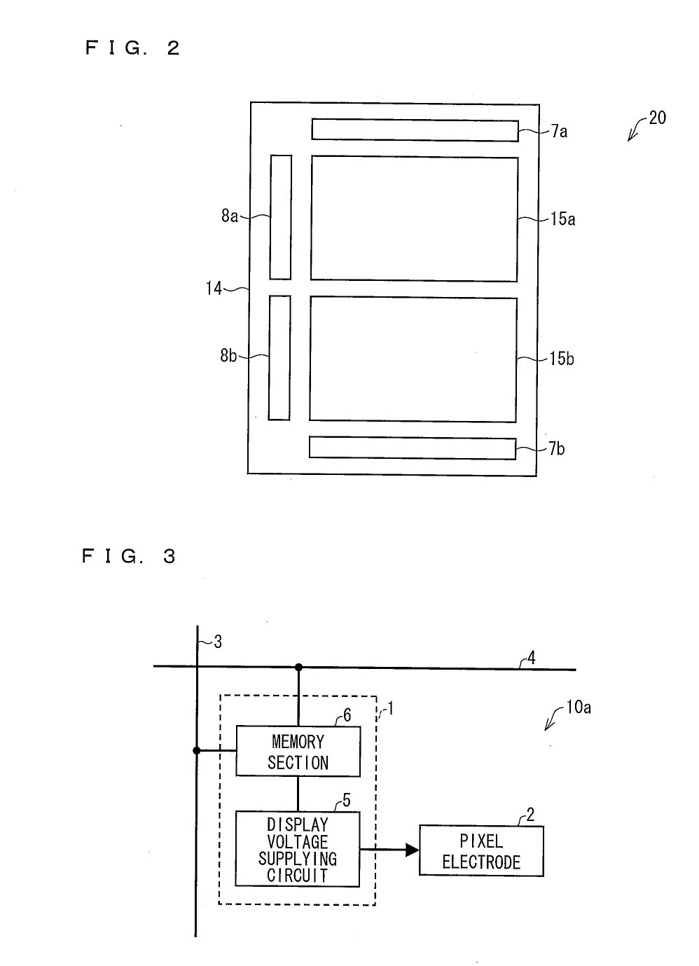

The following description will discuss an embodiment of the present invention with reference to drawings. First, an outline of a liquid crystal display device (LCD) in accordance with the present embodiment is discussed with reference to FIGS. 1 and 2. FIG. 1 is an equivalent circuit diagram illustrating an entire electric configuration of an LCD 20. FIG. 2 is a plan view schematically illustrating an entire configuration of the LCD 20.

As illustrated in FIG. 2, the LCD 20 includes a liquid crystal panel 14 (display screen), signal line driving circuits 7a and 7b, and scanning line driving circuits 8a and 8b. The liquid crystal panel 14 is divided into a display region 15a (first display region) and a display region 15b (second display region), both of which will be described later. In the display region 15a, an image is displayed in accordance with a reflective method or a transflective method. In the display region 15b, an image is displayed in accordance with a transmissive method or the transflective method.

Specifically, as illustrated in FIG. 1, the liquid crystal panel 14 is constituted by a TFT substrate (not shown), a counter substrate (not shown), and a liquid crystal layer which is sandwiched between the TFT substrate and the counter substrate. The liquid crystal panel 14 has a plurality of pixels 10a arranged in matrix and a plurality of pixels 10b arranged in matrix. The liquid crystal panel 14 includes, on the TFT substrate, memory circuits 1, pixel electrodes 2, signal lines 3 (first signal lines and second signal lines), scanning lines 4 (first scanning lines and second scanning lines), and thin-film transistors (TFTs) 13. The liquid crystal panel 14 also includes, on the counter substrate, counter electrodes 9 and counter electrode driving circuits 11a and 11b. In FIG. 1, the reference numeral 12 denotes a liquid crystal cell, which is considered as a capacitor element in an electrical context.

In the display region 15a, (i) the first signal lines 3 are provided, one first signal line 3 per column, so as to be parallel with each other in a column direction (longitudinal direction), and (ii) the first scanning lines 4 are provided, one first scanning line 4 per row, so as to be parallel with each other in a row direction (lateral direction). The first signal lines 3 and the first scanning lines 4 intersect with each other. A pixel 10a is provided to each of the intersections of the first signal lines 3 and the first scanning lines 4. That is, a region surrounded by two adjacent first signal lines 3 and two adjacent first scanning lines 4 is one pixel 10a (first pixel). The pixel 10a has a memory circuit 1 and a pixel electrode 2. The memory circuit 1 is constituted by (i) a memory section 6 for storing a data signal that is supplied from a signal line and (ii) a display voltage supplying circuit 5 for supplying, to the pixel electrode 2, the data signal stored in the memory section 6.

Details of the pixel 10a are illustrated in FIG. 3. FIG. 3 is an enlarged schematic view illustrating the pixel 10a. As illustrated in FIG. 3, the first signal line 3 and a first scanning line 4 are each electrically connected with the memory circuit 1 and the display voltage supplying circuit 5, both of which are provided in a row in which the pixel 10a is provided. Specifically, the first signal line 3 and the first scanning line 4 are each connected with the memory section 6 in the memory circuit 1. The display voltage supplying circuit 5 is provided between the memory section and the pixel electrode 2 so as to be electrically connected with the memory section 6 and the pixel electrode 2. Note that a liquid crystal cell 12 is interposed between the pixel electrode 2 and a counter electrode 9, so that a liquid crystal capacitor is formed by the pixel electrode 2 and the counter electrode 9.

According to this, a data signal supplied from the signal line driving circuit 7a to the first signal line 3 is tentatively written into the memory section 6, via a scanning signal supplied from the scanning line driving circuit 8a to the first scanning line 4. The data signal having been written into the memory section 6 is written into the pixel electrode 2 via the display voltage supplying circuit 5, so that an electric potential of the pixel electrode 2 is set in accordance with the data signal. An electric potential of the counter electrode 9 has been set to a predetermined electric potential by the counter electrode driving circuit 11a. This allows the liquid crystal cell 12, which is interposed between the pixel electrode 2 and the counter electrode 9, to achieve gradation display in accordance with a potential difference between the pixel electrode 2 and the counter electrode 9. Display of an image via the memory circuit 1 will be described later in further detail.

On the other hand, in the display region 15b, (i) the second signal lines 3 are provided, one second signal line 3 per column, so as to be parallel with each other in a column direction (longitudinal direction), and (ii) the second scanning lines 4 are provided, one second scanning line 4 per row, so as to be parallel with each other in a row direction (lateral direction). The second signal lines 3 and the second scanning lines 4 intersect with each other. A pixel 10b is provided to each of the intersections of the second signal lines 3 and the second scanning lines 4. That is, a region surrounded by two adjacent second signal lines 3 and two adjacent second scanning lines 4 is one pixel 10b (second pixel). The pixel 10b has a TFT 13 and a pixel electrode 2. A source electrode of the TFT 13 is electrically connected with a second signal line 3, and a gate electrode of the TFT 13 is electrically connected with a second scanning line 4. A drain electrode of the TFT 13 is electrically connected with the pixel electrode 2. Note that a liquid crystal cell 12 is interposed between the pixel electrode 2 and a counter electrode 9, so that a liquid crystal capacitor is formed by the pixel electrode 2 and the counter electrode 9.

According to this, a scanning signal supplied from the scanning line driving circuit 8b to the second scanning line 4 causes a gate of the TFT 13 to be turned on, and a data signal supplied from the signal line driving circuit 7b to the second signal line 3 is written into the pixel electrode 2. This causes an electric potential of the pixel electrode 2 to be set in accordance with the data signal. An electric potential of the counter electrode 9 has been set to a predetermined electric potential by the counter electrode driving circuit 11b. This allows the liquid crystal cell 12, which is interposed between the pixel electrode 2 and the counter electrode 9, to achieve gradation display in accordance with a potential difference between the pixel electrode 2 and the counter electrode 9.

As described above, in the display region 15a, the first signal lines 3 are controlled by the signal line driving circuit 7a, and the first scanning lines 4 are controlled by the scanning line driving circuit 8a. The display region 15a is therefore driven by the signal line driving circuit 7a and the scanning line driving circuit 8a. In the display region 15b, on the other hand, the second signal lines 3 are controlled by the signal line driving circuit 7b, and the second scanning lines 4 are controlled by the scanning line driving circuit 8b. The display region 15b is therefore controlled by the signal line driving circuit 7b and the scanning line driving circuit 8b. Thus, the display region 15a and the display region 15b in accordance with the present embodiment can be driven independently.

(Mechanism of How Memory Circuit 1 Operates)

As described above, the LCD 20 in accordance with the present embodiment has the display region 15a and the display region 15b, and each of the pixels 10a constituting the display region 15a is provided with a memory circuit 1. The following description will discuss the memory circuit 1 in detail.

The memory circuit 1 is a circuit which is capable of storing image data of a static image or the like. As such, writing the image data, which is stored in the memory circuit 1, into the pixel electrode 2 allows displaying an image without supplying the image data from the outside. That is, in a case of displaying the same image data in the display region 15a, it is possible to display an image without continuing to supply the image data from the outside. This eliminates the need for supply of image data from the outside, and an image can be displayed with low electric power consumption, accordingly. Specifically, once image data is written into the memory circuit 1, it becomes unnecessary to charge and discharge the first signal line 3 by use of the image data so as to supply the image data to the pixel 10a. This allows a reduction in electric power consumption which may otherwise be increased due to charging and discharging of the first signal line 3. In addition, it is unnecessary to transmit the image data from the outside of the liquid crystal panel 14 to a liquid crystal driver. This allows a reduction in electric power consumption which may otherwise be increased due to the transmission.

The memory circuit 1 in accordance with the present embodiment can be a general memory circuit such as a pixel memory provided in a pixel. An SRAM memory circuit or a DRAM memory circuit has been developed as the memory circuit 1.

The memory circuit 1 which is applicable to the present embodiment will be briefly described. As described above, the memory circuit 1 is constituted by the memory section 6 and the display voltage supplying circuit 5. Since the memory circuit 1 can be a conventional memory circuit, detailed description of an internal structure of the memory circuit 1 will be omitted. The memory circuit 1 can be, for example, the memory circuit disclosed in Japanese Patent Application Publication, Tokukai, No. 2007-286237 A, but is not particularly limited to this.

A flow of display carried out in the display region 15a by use of the memory circuit 1 is briefly described. First, a high level electric potential is supplied to the first scanning line 4, so that a data signal supplied from the first signal line 3 is written into the memory section 6. After the data signal is written, the electric potential of the first scanning line 4 is kept to a low level, so that the data signal which has been written into the memory section 6 is held.

Then, the display voltage supplying circuit 5 causes the data signal held in the memory section 6 to be written into the pixel electrode 2, so that gradation display is carried out in accordance with the data signal. The provision of the memory circuit 1 in the pixel 10a in the display region 15a allows writing the data signal, which has been stored in the memory circuit 1, into the pixel electrode 2 of the pixel 10a. As such, in a case of displaying the same image data of a static image or the like, a data signal stored in the memory circuit 1 can be supplied to the pixel 10a, and it is unnecessary to supply the data signal to the pixel 10a in every frame. That is, since it is unnecessary to drive the signal line driving circuit 7a and the scanning line driving circuit 8a, it is possible to reduce electric power consumption.

Note that it is preferable that the image data stored (held) in the memory circuit 1 have a relatively small amount of information which is updated relatively less frequently. For example, in a mobile phone, the image data is a static image of an icon of an antenna, an icon indicative of battery level, or the like. Such image data having a small amount of information can be stored in the memory circuit 1. In addition, in a case where the information of the image data is updated less frequently (i.e., switching between images is carried out less frequently), the same image data can be used continuously. This eliminates the need for supplying new image data to the pixel 10a every time an image is changed (updated). Consequently, electric power consumption is further reduced.

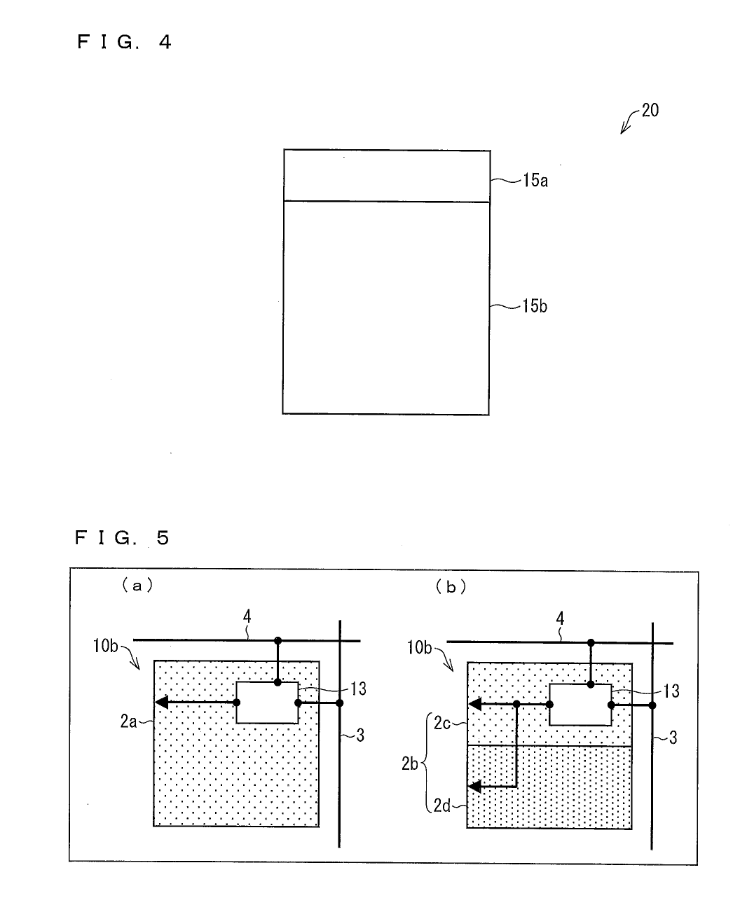

As described above, in a case where a static image of an icon of an antenna on a mobile phone, an icon indicative of battery level on the mobile phone, or the like is stored in the memory circuit 1, the LCD 20 can have display regions as illustrated in FIG. 4. FIG. 4 is a view illustrating an example of arrangement of the display region 15a and the display region 15b. Thus, neither the display region 15a nor the display region 15b is limited to any specific size. Each of the display region 15a and the display region 15b can be designed to have a desired size.

(Configurations of Display Region 15a and Display Region 15b)

As described above, the LCD 20 in accordance with the present embodiment has two display regions. One of the two display regions is the display region 15a in which display is carried out in accordance with the reflective method or the transflective method, and the other of the two display regions is the display region 15b in which display is carried out in accordance with the transmissive method or the transflective method. In a case where display is carried out in accordance with the reflective method in the display region 15a, a reflecting electrode that reflects light from the outside is used as the pixel electrode 2. In a case where display is carried out in accordance with the transflective method in the display region 15a, a transflective electrode, a part of which is constituted by an electrode that transmits light from a backlight and another part of which is constituted by an electrode that reflects light from the outside, is used as the pixel electrode 2. Similarly, in a case where display is carried out in accordance with the transmissive method in the display region 15b, a transmissive electrode that transmits light from the backlight is used as the pixel electrode 2. In a case where display is carried out in accordance with the transflective method in the display region 15b, a transflective electrode, a part of which is constituted by an electrode that transmits light from the backlight and another part of which is constituted by an electrode which reflects light from the outside, is used as the pixel electrode 2.

The pixel 10b in the display region 15b is schematically illustrated in FIG. 5. (a) of FIG. 5 is an enlarged schematic view illustrating the pixel 10b corresponding to a case in which the transmissive method is employed in the display region 15b. (b) of FIG. 5 is an enlarged schematic view illustrating the pixel 10b corresponding to a case in which the transflective method is employed in the display region 15b.

As illustrated in (a) of FIG. 5, in a case where display is carried out in accordance with the transmissive method in the display region 15b, a transmissive electrode 2a is used as the pixel electrode 2. In this case, the display region 15b is designed so that the drain electrode of the TFT 13 is electrically connected with the transmissive electrode 2a. On the other hand, as illustrated in (b) of FIG. 5, in a case where display is carried out in accordance with the transflective method in the display region 15b, a transflective electrode 2b, which has (i) a transmissive part 2c constituted by an electrode that transmits light from the backlight and (ii) a reflective part 2d constituted by an electrode that reflects light from the outside, is used as the pixel electrode 2. In this case, the display region 15b is designed so that the drain electrode of the TFT 13 is electrically connected with each of the transmissive part 2c and the reflective part 2d. The same applies to a case in which display is carried out in accordance with the transflective method in the display region 15a.

As described above, in a case where display is carried out in accordance with the reflective method in the display region 15a, it is unnecessary to provide a backlight in the display region 15a. This allows a further reduction in electric power consumption. A reduction in electric power consumption is achieved also in a case where display is carried out in accordance with the transflective method in the display region 15a, since combined use of the reflective method and the transmissive method shortens time during which the backlight is in an on-state. Thus, by carrying out display in accordance with the reflective method or the transflective method in addition to providing the memory circuit 1 in the display region 15a, it becomes possible to achieve a further reduction in electric power consumption.

In addition, also in the display region 15b, it is possible to further reduce electric power consumption by employing the transflective method and thereby reducing time during which the backlight is in an on-state. The employment of the reflective method or the transflective method as a display method of the LCD 20 allows a further reduction in electric power consumption.

(Modified Example of LCD 20)

In the LCD 20 as described above, the signal line driving circuits 7a and 7b respectively corresponding to the display regions 15a and 15b, the scanning line driving circuits 8a and 8b respectively corresponding to the display regions 15a and 15b, and the counter electrode driving circuits 11a and 11b respectively corresponding to display regions 15a and 15b are provided. The provision of driving circuits for the respective display regions 15a and 15b permits a case in which the number of pixels in the display region 15a is different from the number of pixels in the display region 15b. In a case where the display regions 15a and 15b are driven by respective different driving methods (AC driving or DC driving), it is preferable that driving circuits corresponding to the respective display regions 15a and 15b be provided as described above.

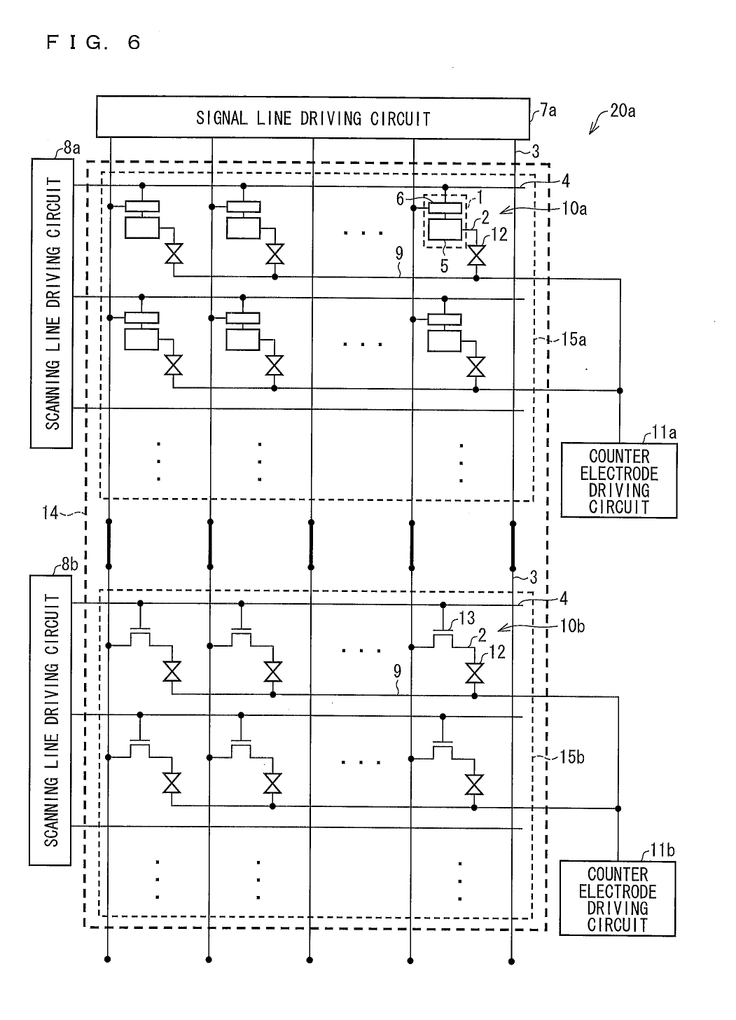

Note, however, that the LCD 20 is not necessarily limited to this, and any of the signal line driving circuits 7a and 7b can be omitted. Details of the LCD 20a corresponding to a case in which the signal line driving circuit 7b is omitted are shown in FIG. 6. FIG. 6 is an equivalent circuit diagram illustrating an entire electric configuration of the LCD 20a.

As illustrated in FIG. 6, in a case where the number of pixels (number of signal lines) in the display region 15a is equal to the number of pixels in the display region 15b, the signal lines 3 can be shared between the display region 15a and the display region 15b (the first signal lines 3 in the display region 15a can be connected with the second signal lines 3 in the display region 15b). In this case, the signal line driving circuit 7b can be omitted, and the signal line driving circuit 7a can be shared between the display region 15a and the display region 15b. Accordingly, the signal line driving circuit 7a controls the signal lines 3 in the display region 15a and the display region 15b.

According to the configuration, the signal line driving circuit 7b can be omitted due to the sharing of the signal lines 3 between the display region 15a and the display region 15b. This allows unnecessary space to be saved. In addition, the configuration enables a reduction in the number of components of the LCD 20a. This allows manufacturing processes to be simplified and manufacturing costs to be reduced, accordingly.

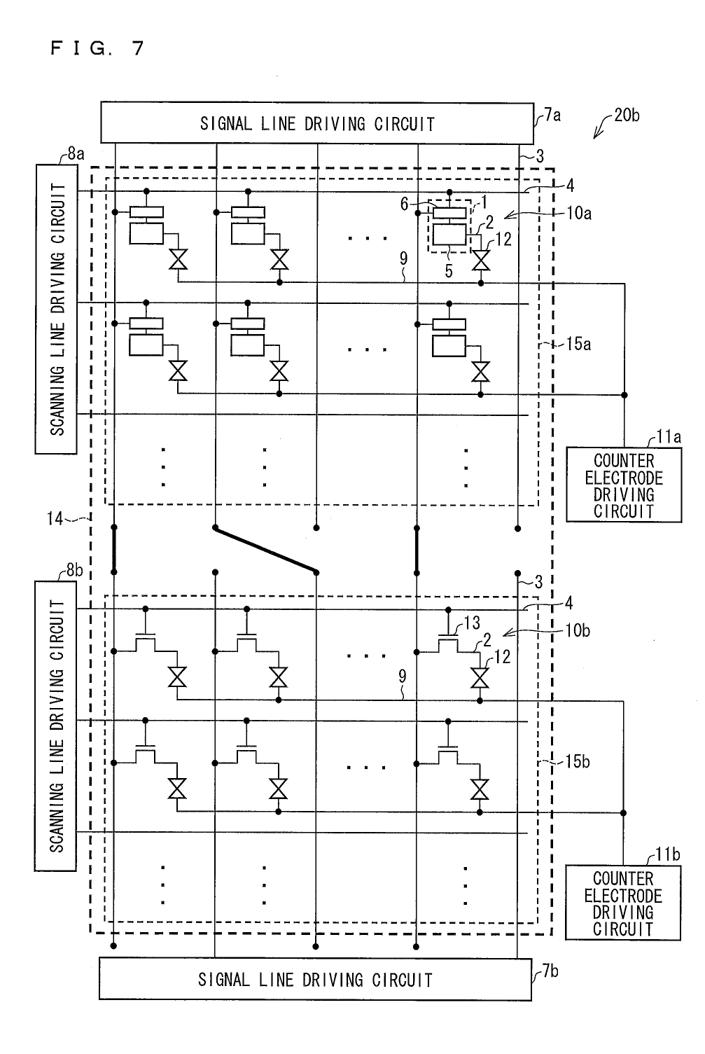

Note that it is also possible to share some of the signal lines 3, even in a case where the number of signal lines differs between the display region 15a and the display region 15b. FIG. 7 illustrates details of the LCD 20b corresponding to a case in which some of the signal lines 3 are shared between the display region 15a and the display region 15b. FIG. 7 is an equivalent circuit diagram illustrating an entire electric configuration of the LCD 20b.

As illustrated in FIG. 7, even in a case where the number of signal lines differs between the display region 15a and the display region 15b, some of the signal lines 3 can be shared (connected). In this case, some of the signal lines 3 are shared and controlled by the signal line driving circuit 7a. In the display region 15a, signal lines 3 that are not shared between the display region 15a and the display region 15b are also controlled by the signal line driving circuit 7a. On the other hand, in the display region 15b, signal lines 3 which are not shared between the display region 15b and the display region 15a are controlled by the signal line driving circuit 7b. According to this, although it is necessary to have the signal line driving circuit 7b, the signal line driving circuit 7b can be small in scale.

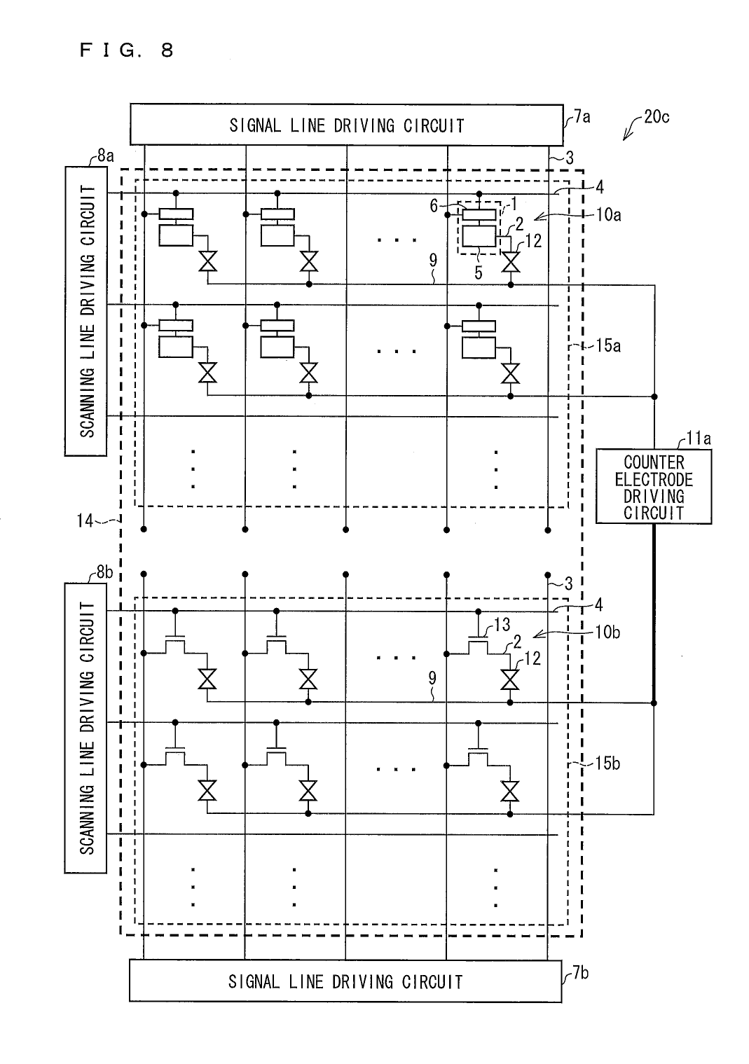

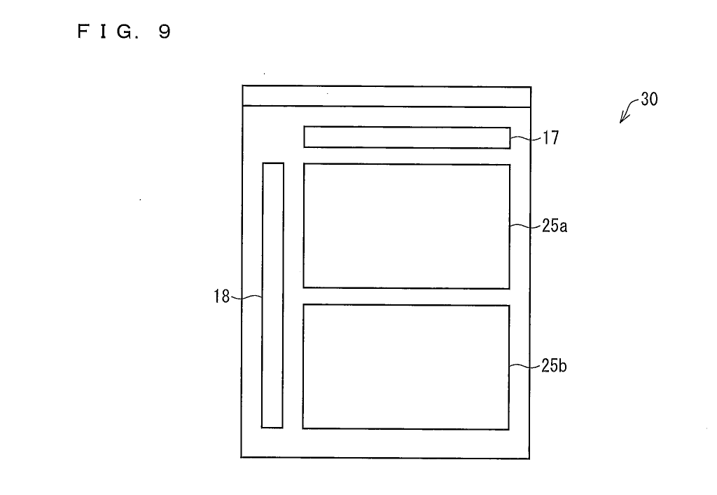

Further, the counter electrode driving circuit 11a can be shared between the display region 15a and the display region 15b so as to omit the counter electrode driving circuit 11b. Details of the LCD 20c in which the counter electrode driving circuit 11b is omitted is illustrated in FIG. 8. FIG. 8 is an equivalent circuit diagram illustrating an entire electric configuration of the LCD 20c.

As illustrated in FIG. 8, the counter electrodes 9 of the pixels 10a in the display region 15a and the counter electrodes 9 of the pixels 10b in the display region 15b can be controlled by the counter electrode driving circuit 11a alone. The sharing of the counter electrode driving circuit 11a between the display region 15a and the display region 15b eliminates the need for providing the counter electrode driving circuit 11b. This allows unnecessary space to be saved because the counter electrode 11b can be omitted. In addition, since the number of components of the LCD 20c can be reduced, the manufacturing processes are simplified and manufacturing costs can be reduced, accordingly.

(DC Driving of Pixel 10a)

The description above discussed a configuration in which the memory circuit 1 is provided in each of the pixels 10a in the display region 15a. Note, however, that the present invention is not necessarily limited to this. For example, it is possible to employ a configuration in which each of the pixels 10a is tentatively DC driven. In this case, like the pixels 10b, a TFT 13 and a pixel electrode 2 are provided to each of the pixels 10a. A source electrode of the TFT 13 is electrically connected with a first signal line 3, and a gate electrode of the TFT 13 is electrically connected with a first scanning line 4. A drain electrode of the TFT 13 is electrically connected with the pixel electrode 2. Note that liquid crystal cell 12 is interposed between the pixel electrode 2 and the counter electrode 9, so that a liquid crystal capacitor is formed by the pixel electrode 2 and the counter electrode 9. A storage capacitor line is capacitively coupled to the pixel electrode 2 provided in each line, so that a storage capacitor (auxiliary capacitor) is formed by the storage capacitor line and the pixel electrode 2.

First, the following description will discuss a case in which the pixel 10a is DC-driven when display is carried out in accordance with the reflective method in the display region 15a. Initially, while an image is displayed in the display region 15a, (i) the pixel 10a having been AC-driven is DC-driven for a short time and (ii) then driving of the display region 15a is stopped. That is, the driving circuits (the signal line driving circuit 7a, the scanning line driving circuit 8a, and the counter electrode driving circuit 11a) in the display region 15a are stopped.

The tentative DC driving of the display region 15a and the subsequent stopping of the DC driving causes an electric charge of a fixed polarity to be accumulated in liquid crystal capacitors and auxiliary capacitors in all the pixels 10a. This brings about a state in which a DC electric field is applied to the liquid crystal cells. This causes image sticking in the display region 15a. Accordingly, in the display region 15a, (i) a contrast becomes lower than before the DC driving was stopped, but (ii) a state in which an image had been displayed immediately before the DC driving was stopped is maintained. It is thus possible to keep the image displayed while the driving has been stopped.

Next, the following description will discuss a case in which the pixel 10a is DC-driven when display is carried out in accordance with the transflective method in the display region 15a. Initially, a backlight is turned off while an image is displayed in the display region 15a. Note that it is necessary to provide separately (i) a backlight for irradiating the display region 15a with light and (ii) a backlight for irradiating the display region 15b with light, since a backlight is turned off only in a part that corresponds to the display region 15a. Accordingly, a part of the pixel 10a which part is constituted by an electrode that transmits light from the backlight shows black display. Subsequently, the pixel 10a having been AC-driven driving is DC-driven for a short time, and then driving of the display region 15a is stopped. That is, the driving circuits (the signal line driving circuit 7a, the scanning line driving circuit 8a, and the counter electrode driving circuit 11a) in the display region 15a are stopped.

The tentative DC driving of the display region 15a and the subsequent stopping of the DC driving causes an electric charge of a fixed polarity to be accumulated in a liquid crystal capacitor and an auxiliary capacitor in a part of the pixel 10a which part is constituted by an electrode that reflects light from the outside. This brings about a state in which a DC electric field is applied to the liquid crystal cell 12. This causes image sticking in the display region 15a. Accordingly, in the display region 15a, (i) a contrast becomes lower than before the DC driving was stopped, but (ii) a state in which an image which had been displayed immediately before the DC driving was stopped. It is thus possible to keep the image displayed while the driving has been stopped.

As described above, in a case where the same image data is displayed in the display region 15a, it is possible to utilize an image sticking phenomenon in the display region 15a to display the image data in a state where driving of the display region 15a has been stopped. Accordingly, while no update of the image data in the display region 15a is carried out (or while the image sticking phenomenon is maintained), it is not necessary to drive the driving circuits. This can save electric power consumption.

Note that, for example, when the display region 15a is driven again in a case where the image displayed in the display region 15a is changed (updated), the image sticking phenomenon may remain in the display region 15a. However, this does not affect display quality, since AC driving is carried out so as to an image in the display region 15a.

The present invention is not limited to the above-described embodiments but allows various modifications within the scope of the claims. In other words, any embodiment derived from a combination of two or more technical means appropriately modified within the scope of the claims will also be included in the technical scope of the present invention.

[Overview of Embodiment]

As described above, in the liquid crystal display device in accordance with the present invention, information is displayed in the first display region in accordance with a reflective method or a transflective method, and information is displayed in the second display region in accordance with a transmissive method or the transflective method.

According to the configuration, it is not necessary to provide a backlight in the first display region in a case where display in the first display region is carried out according to the reflective method. This allows a further reduction in electric power consumption. In addition, in a case where display is carried out in accordance with the transflective method in the first display region, the reflective method and the transmissive method can be used in combination, so that a backlight is in an on-state for a shorter period of time. This allows a reduction in electric power consumption. As such, carrying out display in accordance with the reflective method or the transflective method in addition to providing a memory circuit in the first display region allows electric power consumption to be further reduced.

Also in the second display region, employing the transflective method reduces a time during which a backlight is in an on-state, so that electric power consumption can be further reduced. The employment of the reflective method or the transflective method as a display method for the liquid crystal display device in accordance with the present invention allows a further reduction in electric power consumption.

In the liquid crystal display device in accordance with the present invention, each of the plurality of first pixels including, as the pixel electrode, an electrode for reflecting light or an electrode which is constituted by a part for reflecting light and a part for transmitting light, and each of the plurality of second pixels including, as the pixel electrode, an electrode for transmitting light or an electrode which is constituted by a part for reflecting light and a part for transmitting light.

The configuration allows (i) the first pixel to be capable of displaying the information in accordance with the reflective method or the transflective method and (ii) the second pixel to be capable of displaying the information in accordance with the transmissive method or the transflective method.

In liquid crystal display device in accordance with the present invention, the plurality of signal lines include a plurality of first signal lines which are included in the first display region and a plurality of second signal lines which are included in the second display region, the plurality of first signal lines being different from the plurality of second signal lines.

According to the configuration, the first display region and the second display region can be driven independently. This permits a case in which the number of signal lines constituting the first display region is different from the number of signal lines constituting the second display region.

In the liquid crystal display device in accordance with the present invention, the plurality of signal lines include a plurality of first signal lines which are included in the first display region and a plurality of second signal lines which are included in the second display region, at least one of the plurality of first signal lines being connected with one of the plurality of second signal lines.

According to the configuration, the signal lines can be shared at least partially between the first display region and the second display region. Accordingly, one(some) of the signal lines constituting the second display region can be driven together with the signal lines constituting the first display region. This allows the circuit for driving the signal lines in the first display region and the circuit for driving the signal line the second display region to be reduced in size.

In the liquid crystal display device in accordance with the present invention, each of the plurality of first signal lines is connected with one of the plurality of second signal lines.

According to the configuration, the signal lines can be shared between the first display region and the second display region. This eliminates the need for separately providing a circuit for driving the signal lines constituting the first display region and a circuit for driving the signal lines constituting the second display region. This allows unnecessary space to be saved.

In the liquid crystal display device in accordance with the present invention, information an amount of which is smaller than that of information displayed in the second display region or which is updated less frequently than the information displayed in the second display region is displayed in the first display region.

According to the configuration, image data having a small amount of information can be stored in the memory circuit. In addition, in a case where the information is updated less frequently (i.e., switching between images is carried out less frequently), the same image data can be used continuously. This eliminates the need for supplying new image data to the first pixel every time an image is changed (updated). Consequently, a further reduction in electric power consumption is achieved.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The liquid crystal display device of the present invention can be suitably applied to electronic devices such as a personal computer, a mobile phone, a mobile information terminal, a mobile music player, or a digital camera.

### REFERENCE SIGNS LIST

1: memory circuit
2: pixel electrode
2a: transmissive electrode
2b: transflective electrode
2c: transmissive part
2d: reflective part
3: signal line
4: scanning line
5: display voltage supplying circuit
6: memory section
7a, 7b, and 17: signal line driving circuit
8a, 8b, and 18: scanning line driving circuit
9: counter electrode
10a and 10b: pixel
11a and 11b: counter electrode driving circuit
12: liquid crystal cell
13: thin-film transistor
14: liquid crystal panel
15a and 15b: display region
20, 20a, 20b, 20c, and 30 liquid crystal display device
25a: reflective region
25b: reflective and transmissive region

1. A liquid crystal display device comprising a display screen which includes: a plurality of scanning lines; a plurality of signal lines which intersect with the plurality of scanning lines; and a plurality of pixels provided separately for respective intersections of the plurality of scanning lines and the plurality of signal lines,
each of the plurality of pixels including a pixel electrode, a counter electrode facing the pixel electrode, and a liquid crystal layer provided between the pixel electrode and the counter electrode,
the display screen being divided into (i) a first display region which includes a plurality of first pixels as the plurality of pixels and (ii) a second display region which includes a plurality of second pixels as the plurality of pixels, the plurality of second pixels being different from the plurality of first pixels,
each of the plurality of first pixels including a memory circuit for storing a data signal supplied from a corresponding one of the plurality of signal lines.

2. The liquid crystal display device as set forth in claim 1, wherein:
information is displayed in the first display region in accordance with a reflective method or a transflective method, and
information is displayed in the second display region in accordance with a transmissive method or the transflective method.

3. The liquid crystal display device as set forth in claim 2, wherein:
each of the plurality of first pixels including, as the pixel electrode, an electrode for reflecting light or an electrode which is constituted by a part for reflecting light and a part for transmitting light, and
each of the plurality of second pixels including, as the pixel electrode, an electrode for transmitting light or an electrode which is constituted by a part for reflecting light and a part for transmitting light.

4. The liquid crystal display device as set forth in claim 1, wherein:
the plurality of signal lines include a plurality of first signal lines which are included in the first display region and a plurality of second signal lines which are included in the second display region, the plurality of first signal lines being different from the plurality of second signal lines.

5. The liquid crystal display device as set forth in claim 1, wherein:
the plurality of signal lines include a plurality of first signal lines which are included in the first display region and a plurality of second signal lines which are included in the second display region, at least one of the plurality of first signal lines being connected with one of the plurality of second signal lines.

6. The liquid crystal display device as set forth in claim 5, wherein:
each of the plurality of first signal lines is connected with one of the plurality of second signal lines.

7. The liquid crystal display device as set forth in claim 1, wherein:
information an amount of which is smaller than that of information displayed in the second display region or which is updated less frequently than the information displayed in the second display region is displayed in the first display region.
